(19) United States
(12) Patent Application Publication
(10) Pub. No.: US 2011/0155316 A1
(43) Pub. Date: Jun. 30, 2011

(54) APPARATUS AND METHOD FOR APPLYING A COVER TO AN ITEM

(76) Inventors: Dan R. Byme, JR., Lewisville, TX (US); David J. Otto, Lake Orion, MI (US); Clayton Raybourn, South Lyon, MI (US); Mark Jurcak, Harrison Township, MI (US)

(21) Appl. No.: 12/992,297

(22) PCT Filed: May 12, 2009
(86) PCT No.: PCT/US2009/043663

§ 371 Date: Mar. 17, 2011

Related U.S. Application Data
(60) Provisional application No. 61/052,524, filed on May 12, 2008.

(51) Int. Cl. B32B 38/04

(52) U.S. Cl. 156/261; 156/391

(57) ABSTRACT

A tool and method applies a cover to an item receiving face. A base plate has an item receiving surface. A moveable lower plate has a die bore corresponding to the cover receiving surface of the item and a receiving surface for a laminate cover material having an adhesive layer and a decorative base layer. An upper plate includes a channel corresponding with the lower plate die and a punch secured within the upper plate channel and slideably engageable within the die. The punch has a centrally located bore and cutting edge. A compressible member disposed within the punch bore has a curvolinear free end. The upper plate is displaced towards the lower plate in a closed state to slidingly engage the punch within the die and the punch cutting edge punches out the cover while the compressible member presses the cut cover onto the item receiving face.

### RELATED APPLICATIONS

This application claims the benefit of, and priority to, U.S. Provisional Patent Application Ser. No. 61/052,524, filed May 12, 2008, which is incorporated herein by reference in its entirety.

### BACKGROUND

The present disclosure relates generally to an item and, more particularly, to an item having a cover, an apparatus for applying the cover and a method therefore.

Frequently, a first item may be incorporated with a second item. At the same time, due to the functional or operational characteristics of the first item, a portion of the first item may be externally viewable. The externally viewable portion of the first item may be aesthetically enhanced so as not to detract from the overall appearance of the second item. For example, a color, pattern, or the like, of the externally viewable portion of the first item may be selected so as to match or blend with the color or pattern or the like of an adjacent surface of the second item. This may be accomplished using various techniques, such as by the application of paint to the externally viewable portion of the first item, or the like.

In an example of a vehicle, a first item such as a sensor may be positioned on the vehicle so that a portion of the sensor is exposed due to the functional characteristics of the sensor. For example, a sensor may be mounted in a fascia of the vehicle, such as a bumper, so that a sensing face of the sensor is exposed. Frequently, the exposed face of the sensor may be covered using a material such as paint, so as to protect the sensor from the environment or to enhance the overall appearance of the exposed face with respect to an adjacent surface.

While paint works as a covering, it is susceptible to various defects over time that effect the appearance and integrity of the paint covering. Also, within a manufacturing environment, if there are different aesthetic configurations of the second item, than an inventory of first items corresponding with the second item would have to be maintained in order to match the first item with the second item during the manufacturing process. This need increases associated manufacturing cost and complexity.

Thus, there is a need in the art for a cost effective method of applying a cover to the external face of a first item to match an adjacent surface of a second item using a tool that is convenient and portable within a manufacturing environment. Further, there is a need in the art for a cover that retains its integrity and appearance over the life of the product.

### SUMMARY OF THE DISCLOSURE

Accordingly, the present disclosure relates to an apparatus and method for applying a cover to a receiving face of an item that includes a base plate having a receiving surface for the item, a lower plate spaced apart and moveable with respect to the base plate, and the lower plate includes a die corresponding to the cover receiving surface of the item and having a receiving surface for a laminate cover material that includes an adhesive layer and a base layer having a predetermined finish. An upper plate includes a channel corresponding with the die in the lower plate and a punch secured within the upper plate channel and slideably engageable within the die bore. The punch has a centrally located bore, and a lowermost edge forms a cutting edge. A compressible member is disposed within the punch bore and a free end of the compressible member is curvolinear. The upper plate is displaced away from the lower plate when the tool is in an open state and is displaced towards the lower plate in a closed state such that the punch is slidingly disposed within the die and the cutting edge of the punch punches out the cover and the compressible member presses the cut cover onto the receiving face of the item to adhere the cover onto the item.

The method includes the steps of loading the item into the tool and feeding a laminate material onto a cover receiving surface of a lower plate. The method further includes the steps of moving the upper plate from an open state to a closed state, and aligning the item within the die by displacing the lower plate with respect to the upper plate. The punch is slidingly disposed within the die. The method further includes the steps of punching out the cover and pressing the cut cover onto the receiving face of the item to adhere the cover onto the item.

An advantage of the apparatus and method for applying a cover to an external face of a first item using a tool is that the covered external face is aesthetically pleasing with respect to an adjacent surface of a second item. Another advantage of the apparatus and method for applying a cover to an external face of a first item using a tool is that the cover on the external face does not interfere with the functionality or operation of the first item. Still another advantage of the apparatus and method for applying a cover to an external face of a first item using a tool is that the cover is applied using a tool during manufacture or assembly of the second item, in a convenient and cost effective manner within a manufacturing environment. Still yet another advantage of the apparatus and method for applying a cover to an external face of a first item using a tool is that the cover is applied accurately and uniformly. A further advantage is that a method is provided for applying a cover to a sensor using a tool that is portable. Yet a further advantage of the apparatus and method for applying a cover to an external face of a first item using a tool is that the scrap material is minimized. Still yet a further advantage of the apparatus and method for applying a cover to an external face of a first item using a tool is that the cover is a laminate material with a solid color layer so that any scratch or damage to the surface of the cover is minimized.

Other features and advantages of the present disclosure will become readily appreciated as the same becomes better understood after reading the following description when considered in conjunction with the accompanying drawings

### DESCRIPTION OF THE DRAWINGS

FIG. 1 is a partial view of a second item or vehicle with a first item incorporated therein;

FIG. 2 is an enlarged plan view of a cover for the first item of FIG. 1;

FIG. 3a is an elevational side view of a sensor illustrating application of the cover to a sensor;

FIG. 3b is another elevational side view of the sensor illustrating application of the cover to a sensor;

FIG. 3c is an elevational side view of a sensor with a cover;

FIG. 4 is a perspective front view of a tool for applying a cover to a first item;

FIG. 5 is a perspective rear view of the tool of FIG. 4;

FIG. 6 is an exploded front view of the tool of FIG. 4;

FIG. 7 is a perspective front view of the tool of FIG. 4 in a closed state;

FIG. 8 is a perspective end view of the tool of FIG. 4 in a closed state;

FIG. 9 is a perspective front view of the tool of FIG. 4 in an open state;

FIG. 10 is a perspective front view of the tool of FIG. 4 in a closed state;

FIG. 11 is an elevational view of a laminate material for the cover;

FIG. 12 is a flowchart of a method for applying a cover to an item using the tool of FIG. 4.

FIGS. 13a through 13d are enlarged views of the tool of FIG. 4 illustrating a method of applying the cover to the first item;

### DESCRIPTION

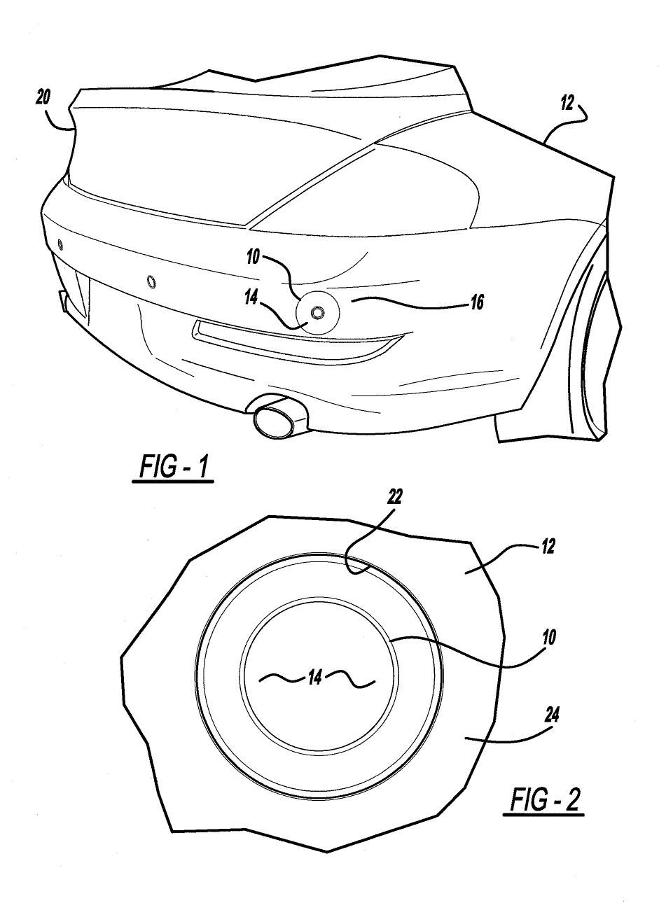

Referring to FIGS. 1-2, a first item 10 incorporated into a second item 12 is illustrated, whereby the first item 10 has an external surface 14 that is exposed, and the first item exposed external surface 14 is adjacent to an exposed surface of the second item 16. For example, the first item 10 could be an object disposed in an aperture 22 in a second item 12. In this example, the first item 10 is a sensor 18, and the second item is an exterior panel of a vehicle 20, such as a vehicle fascia, and the sensor 18 is disposed within an aperture 22 in the fascia 24. In another example (not shown), the first item is a plug disposed in an aperture in a product. The first item exposed surface 14 may include a cover that matches the finish or appearance, such as color or texture or the like, of the adjacent surface 14 of the second item. In another example, the first exposed surface 14 may be complementary to the adjacent second item exposed external surface 16. The cover enhances the overall aesthetic appearance of the combined first and second items.

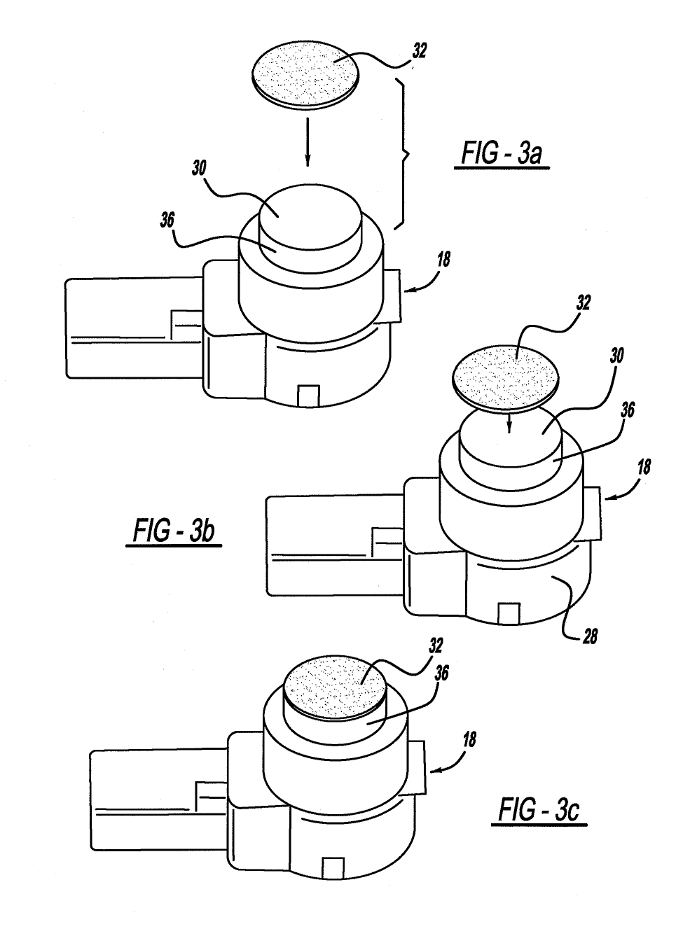

Referring now to FIGS. 3a-3c, an example of a first item, such as a sensor 18, is illustrated. Sensors 18 are generally utilized to communicate information. For example, an ultrasonic sensor may be utilized to transmit and receive ultrasonic signals, such as sound waves, which are then communicated to another device, such as a processor. The sensor 18 includes a housing 28 that protects the components contained within. The housing 28 may be fabricated from a variety of materials, depending on the use of the sensor 18, such as plastic, or metal or the like. The housing 28 includes an exterior surface and an interior surface. A portion of the housing 28 includes a signal transmitting and receiving area or face 30 that is exposed when the sensor 18 is disposed within the second item 12 or vehicle 20 of this example. The exposed face 30 of the housing 28 may be a different material than the rest of the housing in order to facilitate transmission or receipt of the signal.

The housing 28 also includes a cover 32 applied to the exterior surface of the housing, so as to cover the exposed face 30. The cover 32 may be selected to match, complement or otherwise coordinate with the finish or appearance of the adjacent second item external surface 16. In this example, the cover 32 is a film material 34 having a laminate structure. The selection of cover material 34 is dependent on various factors, such as the shape of the exposed housing face 30, functional needs, or ability to withstand normal wear and tear, aesthetics, or the like. An example of a cover material 34 is a flexible plastic film having a laminate structure, as shown in FIG. 11. The cover material 34 has at least two layers. The choice of sheet layer material is nonlimiting, and the selection is influences by factors such as the housing material, shape of the housing, aesthetics, durability or the like. The cover 32 should adhere to the desired surface without aesthetic defects. In an example, the total thickness of the laminate material is about 0.1087 mm, which is similar to a corresponding thickness of a layer of paint. In this example, thickness of the laminate structure is selected so as to facilitate proper functioning of the sensor 18. Additionally, the material may be flexible to accommodate various shapes of the housing 28.

A first layer 34a of material is adjacent the exposed face 30 of the housing 28, and is an adhesive layer that secures or adheres the cover material 34 to the housing 28. Various types of adhesives may be utilized, depending on the surface of the housing 28 to which it adheres. The adhesive layer 34a is used to secure the cover 32 to the sensor housing 28 during the application process. An example of an adhesive is a self cross-linking acrylic copolymer solution using 2-ethylhexyl as the main building block as it has a good balance of tack, peel and shear resistance. The first, adhesive layer 34a has a predetermined thickness depending on the application, such as about 0.31 mm.

A second layer 34b of material is adjacent the adhesive layer 34a, and forms a base layer 34b. Various types of material may be selected for the base layer 34b, depending on the usage. The base layer 34b may be a plastic or polymeric material or a metal or foil material, depending on the usage. Material examples include but are not limited to polyurethane, polyvinylidene fluoride, polyvinyl chloride (PCV), cast polypropylene (CPP), polyethylene terphalate (PET), aluminum foil (AL), EVOH, polyethylene or nylon (ONO) or the like. The base layer 34b has a predetermined thickness. In this example, the base layer 34b has a thickness of about 0.06 mm, and the material is a cast polyvinyl chloride (PVC).

A third layer 34c is adjacent the base layer 34a, and forms a predetermined decorative layer 34c. The decorative layer 34c provides a finish and may be conducive to either pigment, coloration, or a coating or the like. Similarly, the decorative layer 34c may be conducive to having a texture, or the like. The decorative layer 34c may be selected to match the adjacent color or texture of finish of the adjacent second item exposed external surface, such as to match the color or another quality such as shininess. An example of a decorative layer is an acrylic having a predetermined color, such as by applying an acrylic ink, an acrylic based material, or other synthetic resin based material, which is applied over the base layer. Another example of a decorative layer 34c is a chrome finish.

The cover material may include a fourth or top layer 34d. The fourth or top layer 34d may provide a protective layer for the laminate structure of the cover. An example of a top layer 34d is a top coat applied over the surface of the previous layers. In an example, the top layer 34d may have a predetermined gloss or sheen. The top layer 34d material may be selected to improve long term durability of the cover. An example of a material is a urethane-based mixture, or the like.

In another example, the laminate material includes a fifth, removable protective layer 34e placed adjacent the adhesive layer 34a in order to protect the adhesive layer 34a until application on the sensor 18. For example, the removable layer 34e may be a paper material.

In still another example, the adhesive layer 34a is applied directly to the housing 28, and the cover 32 is applied over the adhesive layer 34a. In yet a further example, the base layer 34b and decorative layer 34c is integrally formed in the same layer.

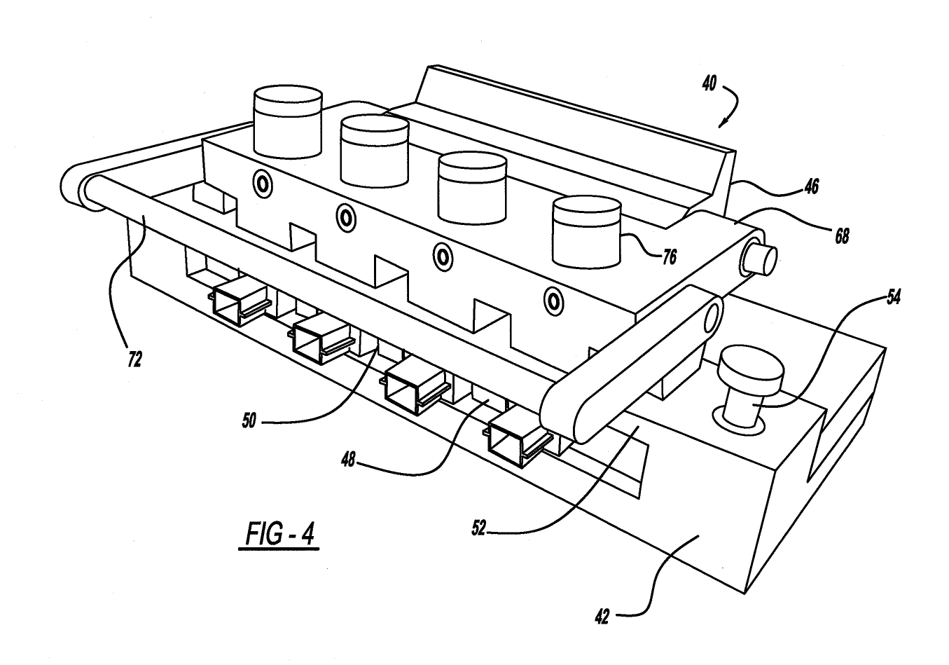

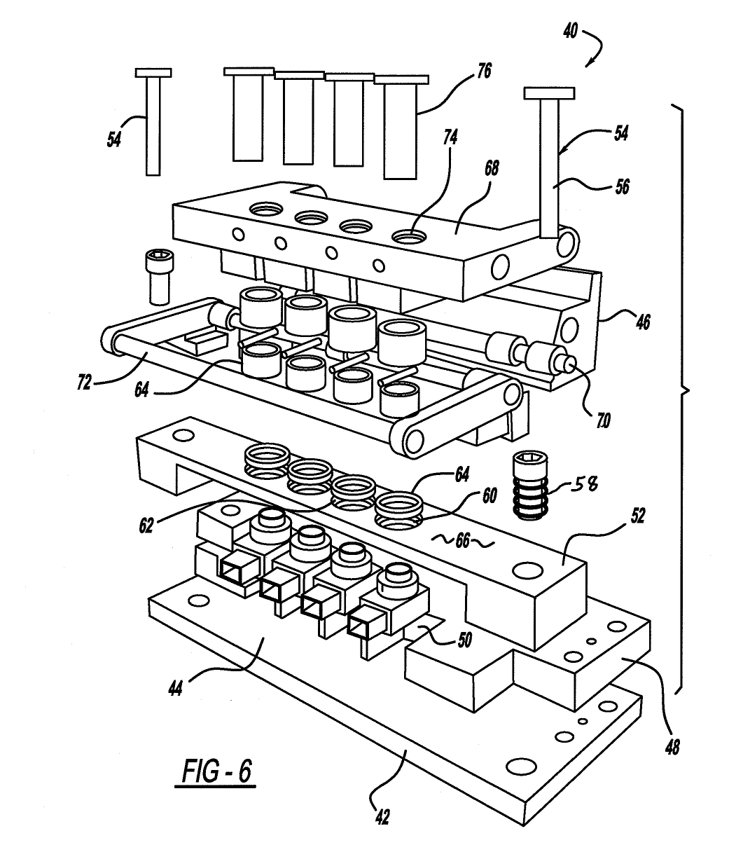

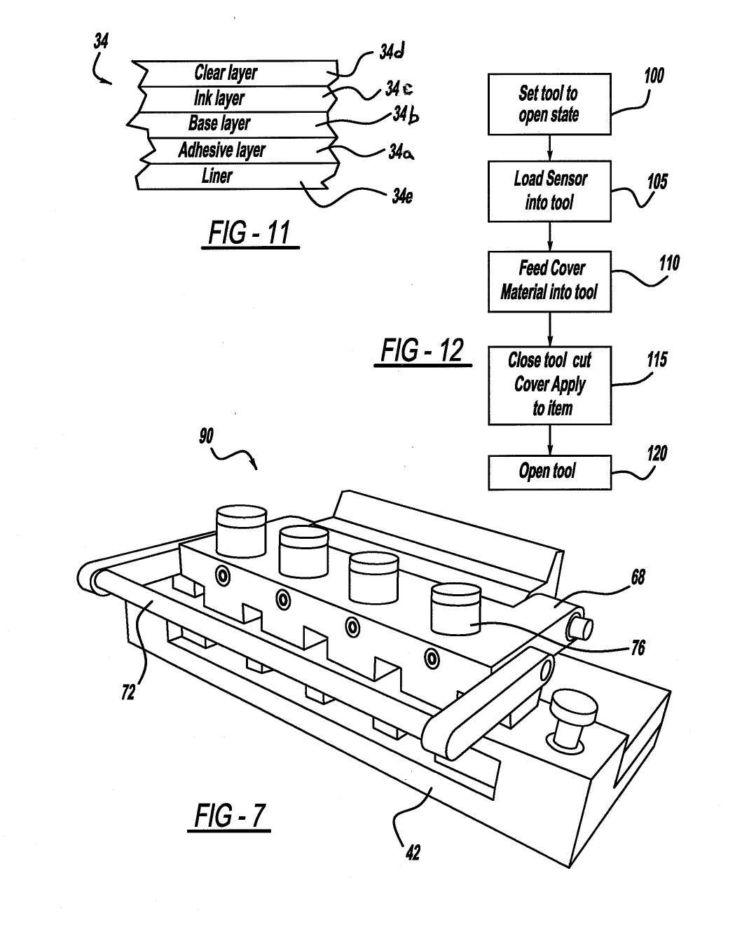

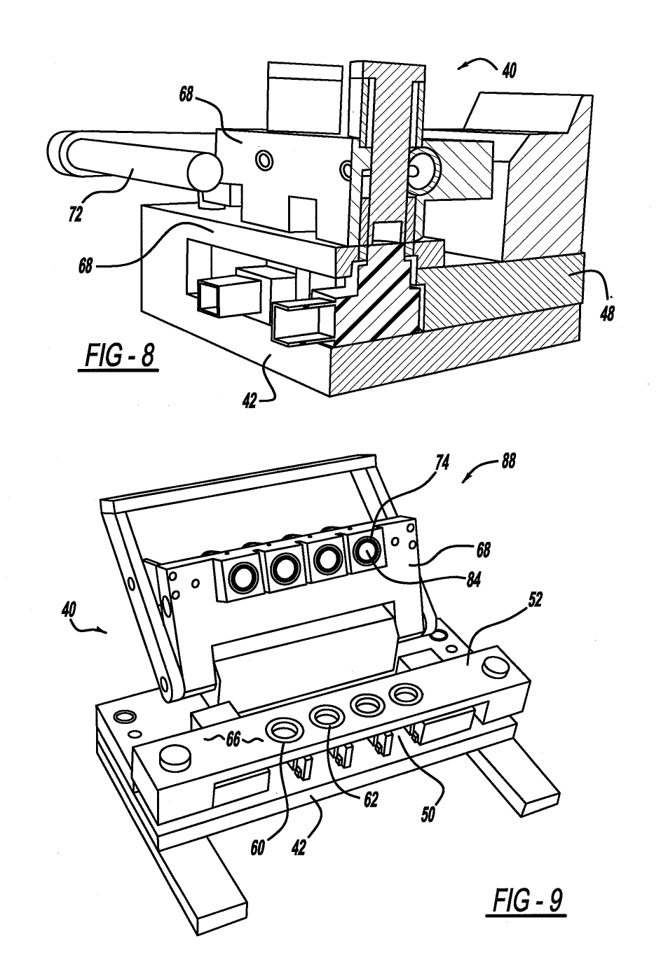

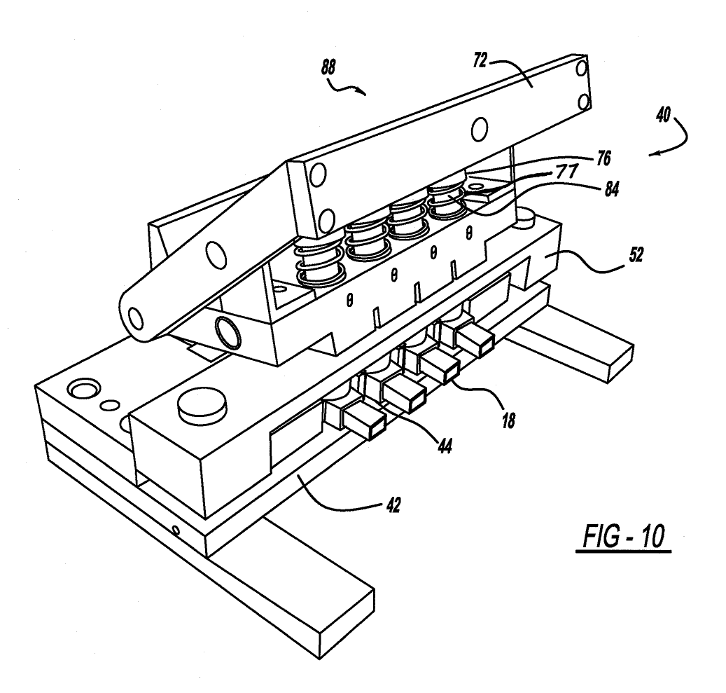

Referring to FIGS. 4-12, a tool 40 for applying the cover 32 to the face 30 of the first item exposed external surface 14, or sensor 18 of this example, is illustrated. The tool 40 receives the first item 10, and the cover material 34 to be attached to the sensor 18. The tool 40 cuts the cover material 34 into a predetermined size and shape, and secures it over the exposed face 30 of the first object 10. The tool 40 can reliably, consistently and accurately align and apply the material to the exposed face, without air bubbles, wrinkles, or creases or the like. The cover 32 is durable, and retains its appearance over time. In the example of a sensor, the cover does not interfere with its operation. Further, the tool 40 can simultaneously apply a cover 32 to the exposed face 30 of a plurality of first items 10, such as the sensors 18 of this example.

The tool 10 may be implemented within a stand alone station for applying a cover 32 to the face 30 of the first object 10. The tool 40 may be portable, so that the covers 32 can be applied to the face 30 of the first object 10 directly on an assembly line for assembling the second item. Likewise, the tool 10 may be integrated with an automated machine that combines various manufacturing operations at one or more stations.

The tool 10 is a punch tool that aligns the first item 10, cover material 34, cuts the cover 32 out of the cover material 34 and applies the cover 32 in a single operation. The tool 40 includes a base plate 42, that is stationary. In this example, the base plate 42 is generally planar and provides a receiving surface 44 for the first item 10. The base plate 42 further includes an upstanding wall 46 extending vertically from an end of the base plate 42 for a purpose to be described. The tool 40 also includes an item support plate 48 operatively secured to the base plate 42. The item support plate 48 is generally planar, and includes a cut-out or recessed portion defined by walls as shown at 50 for receiving and supporting the first item 10, or sensor 18 of this example. The size and shape of the recessed portion 50 corresponds to the size and shape of the first item 10. The number of recessed portions 50 corresponds to the number of items 10 simultaneously receiving covers 32.

A generally planar lower plate 52 is spaced a predetermined length apart from the base plate 42. The lower plate 52 is attached to the base plate member 42 via an attachment member 54 that bias the lower plate 52 away from the base plate 42, which in this example is in a vertical direction. An example of an attachment member 54 is a pin 56 and spring 58. In this example there are a pair of attachment members 54, each positioned at and end of the lower plate 52, and the spring 58 is a compression spring. The lower plate 52 includes a plurality of channels forming dies 60, with each die 60 corresponding in size and shape to a cover receiving portion 36 of the first item 10. The cover receiving portion 36 of the first item 10 or sensor 18 of this example is disposed within the die 60. An uppermost surface of each die 60 may include a depression 62 for receiving a bushing 64. The lower plate die 60 is formed using a material, such as hardened steel, and provides a shear surface during the punching of the material. In this example, the die 60 is shaped to create a circular cover 32, in order to accommodate the substantially circular face 30 of the sensor 18. In addition, the die 60 assists in aligning the cover receiving portion 36 of the first item. The upper, planar surface of the lower plate also serves as a receiving surface 66 for the laminate material 34 in a manner to be described.

A generally planar upper plate 68 is pivotally attached to the upstanding wall 46, and is generally perpendicular to the upstanding wall 4. For example, a connector 70 such as a pivot pin or rod, or the like may be utilized to interconnect the upper plate 68 to the upstanding wall 46. The upper plate 68 provides a support for an actuator 72. The actuator 72, such as a handle, is used to pivot the upper plate 68 relative to the lower plate 52 in a manner to be described. The upper plate 68 includes a plurality of channels 74 for receiving a punch 76, with each channel 74 corresponding in placement and number to the lower plate die 60. The number of punches 76 corresponds to the number of dies 60 in the lower plate 52 and each punch 76 is aligned with a die 60 such that during operation of the tool 40, the punch 76 is vertically movable into the die 60 so as to achieve the punching and the application steps. Such operation will be described in more detail. Each punch 76 is biased away from the upper plate 68 by a second spring 77, such as a compression spring and the like.

The punch 76 in this example has a cylindrical shape. A lower edge 78 of the punch 76 engages with the corresponding die 60. The lower edge may be angled to form a beveled cutting edge as shown at 80. The lower portion of the punch also includes a centrally located bore 82 extending at least partially there through the punch 76. The centrally located bore 82 of each punch 76 may have a compressible member 84 disposed therein, such as a mid durometer urathane material or the like. The exposed or free end of the compressible member 84 may extend beyond the bore 82 in the punch 76 as shown at 86. The exposed portion 86 is curvolinear in shape, such as a dome shape. This compressible member 84 is durable yet slightly compressible such that during the process of punching out the cover 32, it is compressed by the die 60. In operation, the dome-shaped compressible member 84 is compressed to assist in applying consistent pressure to the cover 32 in securing the cover 32 to the receiving portion or face 30 of the first item 10.

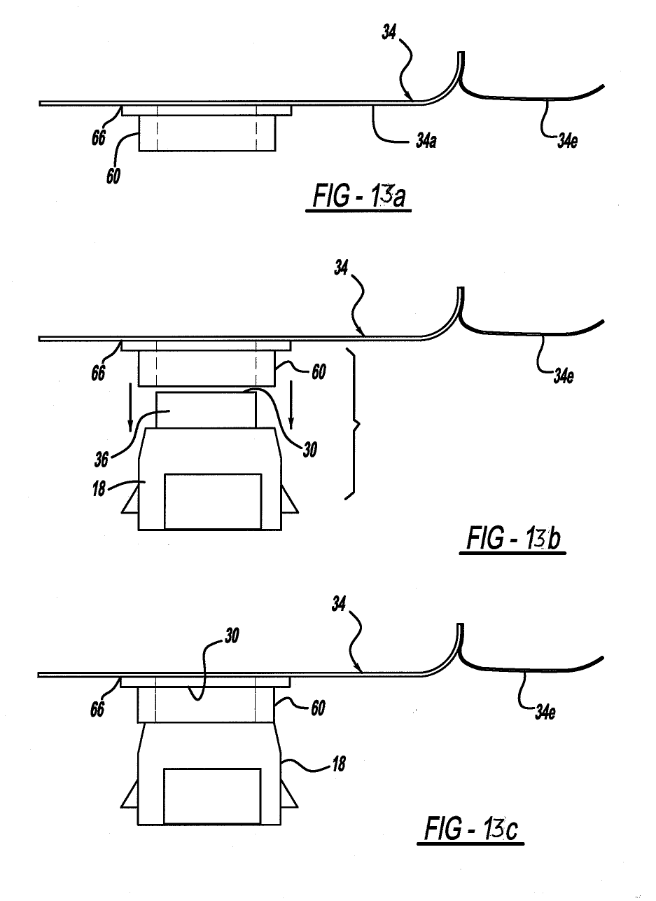

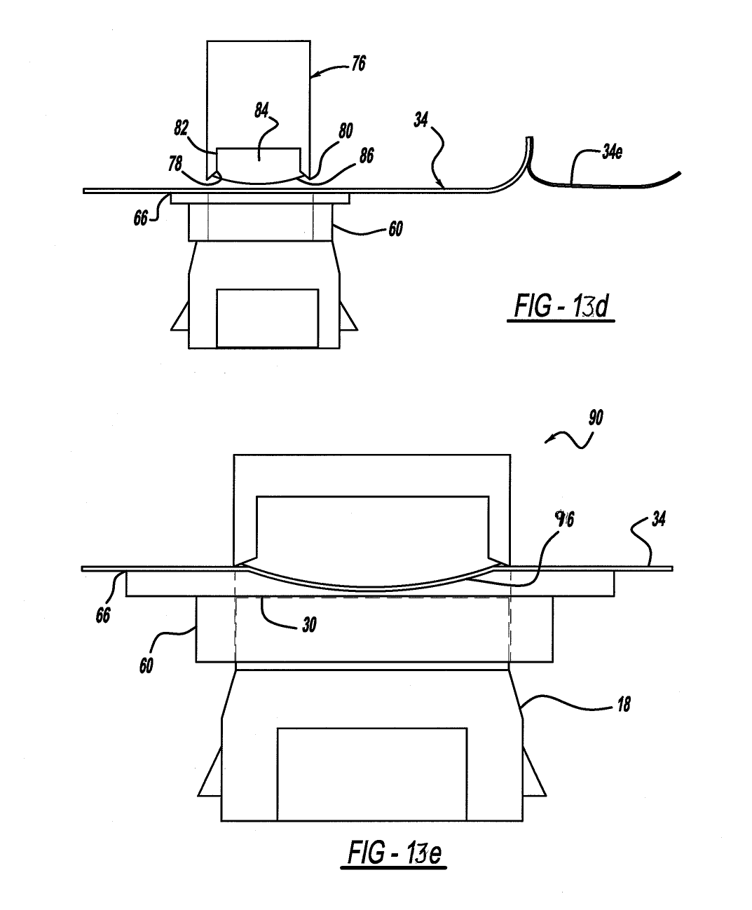

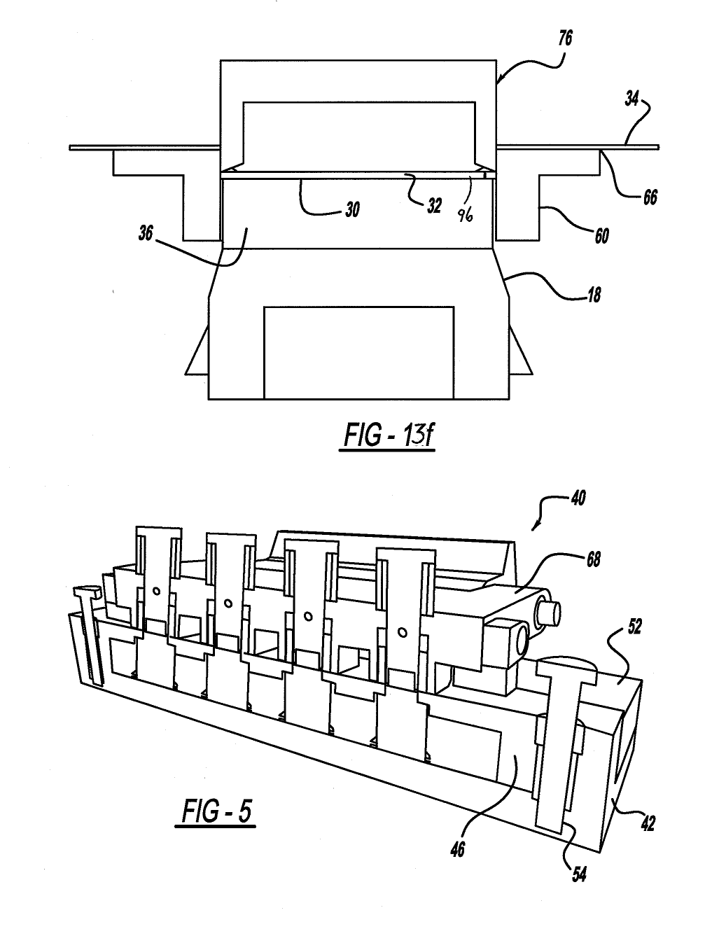

Referring to FIGS. 12 and 13, a method of applying a cover 32 to a first item 10 using the tool 40 is described. The methodology begins in block 100 with the step of initially setting the tool 40 to an open state, as shown at 88. For example, the upper plate 68 is pivoted away from the lower plate 52 by moving the actuator 72 in a corresponding direction. The methodology advances to block 105 and the first item 10, such as the sensors 18 of this example, are loaded into the tool 40. In this example, a sensor 18 is positioned within each recessed portion 50 of the item support plate 48, and base plate receiving surface 44. At the same time, the cover receiving portion 36 of the sensor 18 is disposed within the corresponding channel or die 60 in the lower plate 52, to further align the sensor 18. The sensor 18 may be positioned by an operator in a manual process, or by using a feed mechanism in an automated process.

The methodology advances to block 110 and the cover material 34 is positioned on the material receiving surface 66 of the lower plate 52 as shown in FIG. 13a. Optionally, the backing or protective layer 34e, if present, may be removed from the cover material 34 prior to placement. The cover material 34 is aligned with respect to the lower plate 52. The material 34 is positioned on top of the lower plate 52, thereby covering the die 60. The material may be placed by an operator in a manual process, or fed in using an automated process. The laminate material may be supplied as a sheet or on a roll and unrolled, or the like. The methodology advances to block 115 and the tool 40 is closed, such as by moving the upper plate 68 towards the lower plate 52 using the actuator 72. For example, an operator may utilize the handle to manually pivot the upper plate 68 relative to the base plate 42 towards a closed state as shown in FIG. 13d at 90. Similarly, this operation may be part of an automated process whereby the upper plate 68 is automatically moved to a closed state. For example, the tool is moved between an open and a closed position by an actuator.

In operation, as the upper plate 68 begins to contact and place pressure on the lower plate 52, the lower plate 52 is slightly compressed towards the base plate 42, such that at least a portion of the central bore of the die 60 receives the face of the first item 10 to be covered as shown in FIG. 13b. As shown in FIG. 13c, the cover face 30 of the sensor 18 is aligned within the central bore of the die 60, to ensure that the cover 32 is positioned appropriately. In this example, during this final alignment stage, the cutting edge 80 of the punch 76 does not contact the material 34 or the lower plate 52 until final alignment is achieved. The cutting edge 80 of the punch 76 moves closer to the lower plate 52 and the cutting edge 80 of the punch 76 cuts the cover 32 into the predetermined shape out of the cover material 34 as shown in FIG. 13d at 96. With the addition of pressure, the extended portion 86 of the compressible number 84 presses the cut cover 32 onto the face of the first item 10. For example, the dome shaped surface 86 of the compressible member 84 presses the cover material 34 onto the receiving surface or face 30 of the sensor 18 as shown at 96. Forces on the receiving surface or face of the sensor 18 are directed in an outwardly manner, to smooth out the cover 32, insure that the cover 32 adheres to sensor 18, and avoid air pockets, ridges or the like as the cover 32 is being pressed onto the sensor. This is achieved via the convex design of the compressible member 84 pressing into the hardened punch with the sharp beveled cutting end, as the punch presses against the lower plate 52. Thus as the edges of the punch 76 meet the material 34, they shear the exact shape required from the sheet of material to match the sensor face to be covered.

The methodology advances to block 120 and the tool 40 is then returned to an open state 88. For example, the operator may return the tool 40 to the open state 88 and remove the first item 10 and any scrap material 34. In another example, the scrap material 34 may be repositioned on the lower plate 52 in order to reduce scrapage and waste.

The tool 40 may include other features as is typical. For example, the tool 40 may include features such as bushings or fasteners or the like that facilitate operation of the tool in the manner described above.

The present disclosure has been described in an illustrative manner. It is to be understood that the terminology which has been used is intended to be in the nature of words of description rather than of limitation. Many modifications and variations of the present example are possible in light of the above teachings. Therefore, within the scope of the appended claims, the present disclosure may be practices other than as specifically described.

What is claimed is:

1. A tool for applying a cover to a receiving face of an item, the tool comprising:
a base plate that includes a receiving surface for holding the item;
a lower plate spaced apart from the base plate and moveable with respect to the base plate, wherein the lower plate includes a die bore corresponding to a cover receiving portion of the item and a receiving surface for a laminate cover material, and the cover material includes an adhesive layer and a base layer having a predetermined finish;
an upper plate pivotally attached to the base plate and movable between a closed state and an open state wherein the upper plate includes a channel corresponding with the die in the lower plate;
a punch disposed within the upper plate channel and slideably engageable within the lower plate die, wherein a lower end of the punch includes a centrally located bore, and a lowermost edge of the punch is angled to form a cutting edge;
a compressible member disposed within the punch centrally located bore and a free end of the compressible member is curvolinear in shape, wherein the upper plate is displaced away from the lower plate when the tool is in the open state and is displaced towards the lower plate in the closed state such that the punch is slidingly disposed within the die and the cutting edge of the punch punches out the cover and the free end of the compressible member presses the cut cover onto the receiving face of the item to adhere the cover onto the item.

2. The tool as set forth in claim 1 wherein the base member includes an upstanding wall, and the upper plate is pivotally attached to the upstanding wall.

3. The tool as set forth in claim 1 wherein the lower plate is operatively attached to the base plate via a pin and spring.

4. The tool as set forth in claim 1 further comprising an item support plate operatively secured to the base plate, wherein the item support plate includes a recessed portion forming walls for receiving the item.

5. The tool as set forth in claim 1 further comprising an actuator operatively attached to the upper plate for moving the upper plate between the open state and closed state.

6. The tool as set forth in claim 1 wherein positioning the upper plate in the closed state engages the upper plate with the lower plate to press the lower plate towards the base plate and receive the item within the lower plate die to align the cover receiving portion of the item with the punch.

7. The tool as set forth in claim 1 wherein a die bore has an upper end engageable with the upper plate and an opposite lower end that engages the cover receiving portion of the item to align the receiving face of the item within the die bore.

8. The tool as set forth in claim 1 wherein the free end of the compressible member has a convex shape in an uncompressed state.

9. The tool as set forth in claim 1 wherein the upper plate includes a plurality of punches and the lower plate includes a plurality of corresponding dies for receiving a corresponding number of items, to simultaneously apply covers to each of the plurality of items.

10. The tool as set forth in claim 1 wherein the cover material is a laminate having an adhesive layer, a base layer, a decorative layer and a top layer, so that the cover matches a finish of an external surface adjacent to the item.

11. A tool for applying a cover to an exposed external surface of a sensor and the cover matches a finish of an external surface surrounding the sensor, the tool comprising:
a base plate having a receiving surface for holding a plurality of sensors, wherein the base member includes an upstanding wall;
a sensor support plate operatively secured to the base member, wherein the sensor support plate includes a plurality of recessed portions for receiving a sensor within each of the plurality of recessed portions;
a lower plate spaced apart from the base plate and moveable with respect to the base plate, wherein the lower plate includes a plurality of dies corresponding to a cover receiving portion of the sensor and a receiving surface for a laminate cover material, and the cover material includes an adhesive layer and a base layer having a predetermined finish;
an upper plate pivotally attached to the upstanding wall of the base plate and movable between a closed state and an open state, whereby the upper plate includes a plurality of channels corresponding with each of the plurality of dies in the lower plate;
a plurality of punches secured within each of the plurality of upper plate channels and slideably engageable within a corresponding die bore in the lower plate, wherein a lower end of the punch includes a centrally located bore, and a lowermost edge of the punch is angled to form a cutting edge;
a compressible member disposed within the centrally located bore in each of the plurality of punches, a free end of the compressible member is curvolinear in shape, wherein the upper plate is displaced away from the lower plate when the tool is in an open state and is displaced towards the lower plate in a closed state such that each of the plurality of punches are slidingly disposed within each of the plurality of corresponding dies and the cutting edge of each of the plurality of punches simultaneously cuts out the corresponding cover and the corresponding compressible member within each punch presses the cut cover onto the corresponding receiving face of the sensor, to simultaneously cut and adhere the corresponding cover onto each of the plurality of sensors.

12. The tool as set forth in claim 11 wherein the lower plate is operatively attached to the base via a pin and spring.

13. The tool as set forth in claim 11 further comprising an actuator operatively attached to the upper plate for moving the upper plate between the open state and the closed state.

14. The tool as set forth in claim 11 wherein positioning the upper plate in the closed state engages the upper plate with the lower plate to press the lower plate towards the base plate and receive the item within the lower plate die to align the cover receiving portion of the item with the punch.

15. The tool as set forth in claim 11 wherein a die bore has an upper end engageable with the upper plate and an opposite lower end that engages the cover receiving portion of the sensor to align the receiving face of the sensor within the die bore.

16. The tool as set forth in claim 11 wherein the free end of the compressible member has a convex shape in an uncompressed state.

17. A method for applying a cover to a receiving face of an item using a tool, said method comprising the steps of:
loading the item into the tool, wherein the tool includes a base plate having a receiving surface for holding the item;
feeding a laminate material onto a cover receiving surface of a lower plate that is spaced apart from the base plate and moveable with respect to the base plate, wherein the lower plate includes a die corresponding to the cover receiving surface of the item, and the cover material includes an adhesive layer and a base layer having a predetermined finish;
moving an upper plate pivotally attached to the base plate from an open state to a closed state, whereby the upper plate includes a channel corresponding with the die in the lower plate and a punch secured within the upper plate channel that is slideably engageable within a die bore, wherein a lower end of the punch includes a centrally located bore, and a lowermost edge of the punch is angled to form a cutting edge;
aligning the item within the die by displacing the upper plate with respect to the lower plate, and a free end of a compressible member disposed within the punch centrally located bore and is curvilinear in shape, such that as the punch is slidingly disposed within the die, the cutting edge of the punch punches out the cover, and presses the cut cover onto the receiving face of the item to adhere the cover onto the item.

18. The method as set forth in claim 17 further including the step of positioning the upper plate to engage the upper plate with the lower plate to press the lower plate towards the base plate and to receive the cover receiving portion of the item with a die bore.

19. The method as set forth in claim 17 wherein the upper plate includes a plurality of punches and the lower plate includes a plurality of corresponding dies for receiving a corresponding number of items, to simultaneously apply covers to each of the plurality of items.

20. The method as set forth in claim 17 wherein the cover material is a laminate having an adhesive layer, a base layer, a layer having a predetermined finish and a top layer, so that the cover matches a finish of an external surface adjacent to the item.
